(19) United States
(12) Patent Application Publication
(10) Pub. No.: US 2011/0159370 A1
(43) Pub. Date: Jun. 30, 2011

(54) NONAQUEOUS SECONDARY BATTERY

(76) Inventors: Akira Inaba, Osaka (JP); Masayuki Yamada, Osaka (JP); Hiroshi Sakurai, Osaka (JP); Kazunobu Matsumoto, Osaka (JP)

(21) Appl. No.: 13/062,124

(22) PCT Filed: Oct. 28, 2009
(86) PCT No.: PCT/JP2009/068500

§ 371 Date: Mar. 3, 2011

(30) Foreign Application Priority Data
Oct. 31, 2008 (JP) 2008-280730
Feb. 10, 2009 (JP) 2009-027989
Mar. 12, 2009 (JP) 2009-059203

(51) Int. Cl. H01M 4/131

(52) U.S. Cl. 429/231.1

(57) ABSTRACT

The present invention provides a nonaqueous secondary battery including a positive electrode, a negative electrode and a nonaqueous electrolyte. A porous layer containing an insulating material not reactive with Li is disposed on a surface of the negative electrode active material containing layer opposite to the side facing the negative electrode current collector or a binder in the negative electrode active material containing layer is polyimide, polyamideimide or polyamide; and the negative electrode current collector has a 0.2% proof stress of 250 N/mm² or more or the negative electrode current collector has a tensile strength of 300 N/mm² or more.

### TECHNICAL FIELD

The present invention relates to a nonaqueous secondary battery having a high capacity and a favorable charge/discharge cycle characteristic.

### BACKGROUND ART

High expectations have been placed on the development of nonaqueous secondary batteries because they can produce a high voltage and have a large capacity. In addition to Li (lithium) and Li alloys, natural or artificial graphite carbon materials into/from which Li ions can be intercalated/deintercalated have been applied as negative electrode materials (negative electrode active materials) for nonaqueous secondary batteries.

Recently, however, a further increase in the capacity is demanded of batteries for compact and multifunctional portable devices. For this reason, materials capable of holding Li as much as possible (hereinafter also referred to as “high-capacity negative electrode materials”), such as Si (silicon) and Sn (tin), are receiving attention.

For example, one of such high-capacity negative electrode materials for nonaqueous secondary batteries is SiOₓ, which has such a structure that Si ultrafine particles are dispersed in SiO₂ (e.g., Patent documents 1 to 3). When this material is used as a negative electrode active material, charging/discharging can be performed smoothly because Si that reacts with Li is in the form of ultrafine particles. At the same time, since SiOₓ particles themselves having the aforementioned structure have a small surface area, the material can provide favorable coating properties when they are used to form a coating for forming a negative electrode active material containing layer as well as favorable bonding between the negative electrode active material containing layer and the current collector.

Prior art documents

### Patent Documents

Patent document 1: JP 2004-47404 A

Patent document 2: JP 2005-259697 A

Patent document 3: JP 2007-242590 A

### SUMMARY OF INVENTION

### Problem to be Solved by the Invention

Meanwhile, studies conducted by the inventors of the present invention have revealed the following. When a nonaqueous secondary battery whose capacity has been increased using a high-capacity negative electrode material as described above is produced by placing a wound electrode body obtained by winding a positive electrode and a negative electrode spirally through a separator in a rectangular (rectangular cylinder) outer can or a laminate film outer package, the capacity of the battery may drop as the battery is charged/discharged repeatedly or the thickness of the battery may increase significantly due to swelling of the battery.

With the foregoing in mind, it is an object of the present invention to provide a high-capacity nonaqueous secondary battery with a favorable charge/discharge cycle characteristic and suppressed battery swelling.

### Means for Solving Problem

A first nonaqueous secondary battery of the present invention is a nonaqueous secondary battery including a positive electrode, a negative electrode and a nonaqueous electrolyte. The positive electrode includes a positive electrode current collector, a positive electrode active material containing layer containing an Li-containing transition metal oxide is disposed on at least one side of the positive electrode current collector, the negative electrode includes a negative electrode current collector, a negative electrode active material containing layer containing a negative electrode active material including an element that can be alloyed with Li is disposed on at least one side of the negative electrode current collector, a porous layer containing an insulating material not reactive with Li is disposed on the surface of the negative electrode active material containing layer opposite to the side facing the negative electrode current collector, and the negative electrode current collector has a 0.2% proof stress of 250 N/mm² or more or the negative electrode current collector has a tensile strength of 300 N/mm² or more.

A second nonaqueous secondary battery of the present invention is a nonaqueous secondary battery including a positive electrode, a negative electrode and a nonaqueous electrolyte. The positive electrode includes a positive electrode current collector, a positive electrode active material containing layer containing an Li-containing transition metal oxide is disposed on at least one side of the positive electrode current collector, the negative electrode includes a negative electrode current collector, a negative electrode active material containing layer containing a negative electrode active material including an element that can be alloyed with Li and at least one binder selected from the group consisting of polyimide, polyamideimide and polyamide is disposed on at least one side of the negative electrode current collector, and the negative electrode current collector has a 0.2% proof stress of 250 N/mm² or more or the negative electrode current collector has a tensile strength of 300 N/mm² or more.

The negative electrode active material including an element that can be alloyed with Li has a high capacity. Thus, with the use of this material, the capacity of the nonaqueous secondary battery can be increased. However, when a high-capacity negative electrode material as described above is used as the negative electrode active material, the volume of the material expands significantly as being charged, causing a change in the volume of the negative electrode. Further, the expansion of the negative electrode active material produces an excessive amount of stress, which may lead to a deformation of the negative electrode, such as curving. Thus, due to the deformation such as a change in the volume or curving of the negative electrode, the capacity may significantly drop as the number of repetitions of charging/discharging increases or the thickness of the battery may increase significantly.

For this reason, in the present invention, the porous layer containing an insulating material not reactive with Li is formed on the surface of the negative electrode active material containing layer, or polyimide, polyamideimide, or polyamide is used as a binder in the negative electrode active material containing layer and a negative electrode current collector having a 0.2% proof stress or a tensile strength in a specific value or more is used to suppress deformations resulting from the expansion of the negative electrode active material at the time of charging, such as a change in the volume and curving of the negative electrode. Thus, the charge/discharge cycle characteristic is improved and battery swelling at the time of charging is reduced while increasing the capacity of the nonaqueous secondary battery.

### Effects of the Invention

According to the present invention, a nonaqueous secondary battery having a high capacity and a favorable charge/discharge cycle characteristic can be provided. Further, even when the nonaqueous secondary battery of the present invention is formed in a rectangular (rectangular cylinder) or flat shape having a small thickness relative to the width, battery swelling at the time of charging can be reduced.

### BRIEF DESCRIPTION OF DRAWINGS

FIG. 1 is a schematic cross-sectional view showing one example of a negative electrode used in the nonaqueous secondary battery of the present invention.

FIG. 2 is a graph showing a charge/discharge cycle characteristic of a nonaqueous secondary battery of Example 1 and that of a nonaqueous secondary battery of Comparative Example 1.

FIG. 3 is an X-ray CT image of a transverse section of the nonaqueous secondary battery of Example 1 after a charge/discharge cycle characteristic evaluation.

FIG. 4 is an X-ray CT image of a transverse section of the nonaqueous secondary battery of Comparative Example 1 after a charge/discharge cycle characteristic evaluation.

### DESCRIPTION OF THE INVENTION

The negative electrode used in the nonaqueous secondary battery of the present invention includes, on at least one side of a negative electrode current collector, a negative electrode active material containing layer containing a negative electrode active material including an element that can be alloyed with Li. Further, the negative electrode includes a porous layer (hereinafter may also be referred to as a “coating layer”) containing an insulating material not reactive with Li on the surface of the negative electrode active material containing layer opposite to the side facing the negative electrode current collector or the negative electrode active material containing layer contains a specific binder.

Examples of negative electrode active materials including an element that can be alloyed with Li include simple substances that can be alloyed with Li and materials including an element that can be alloyed with Li. The element that can be alloyed with Li is preferably Si or Sn. Specifically, examples of negative electrode active materials including an element that can be alloyed with Li include: Si or Sn (simple substance thereof); alloys containing Sn (intermetallic compounds such as Cu₆Sn₅, Sn₇Ni₃ and Mg₂Sn); and oxides of Si or Sn. They can be used alone or in combination of two or more.

For example, among the aforementioned alloys, NiAs intermetallic compounds belonging to a P6₃/mmc space group, such as Cu₆Sn₅, are particularly preferred because a nonaqueous secondary battery having favorable reversibility, a large capacity and a favorable charge/discharge cycle characteristic is likely to be formed with the use of any of the compounds. The alloys are not necessarily limited to specific compositions. As for an alloy having a relatively wide solid solution range, it may be slightly shifted from a central composition. Furthermore, another element may be substituted for a part of the aforementioned constituent elements. For example, another element M may be substituted for a main constituent element of the alloy to form a multielement compound, as in Cu_{b-x}MₓSn₅ (x<6) or Cu₆Sn_{5-y}M_{y}, (y<5).

Further, materials containing an Si oxide, in other words, materials including Si (silicon) and O (oxygen) as constituent elements and an atomic ratio x of O to Si is 0.5≦x≦1.5 (hereinafter referred to as “SiOₓ”) are also preferable because the capacity of the nonaqueous secondary battery can be increased further.

SiO may include microcrystalline Si or amorphous Si, and in this case, the atomic ratio between Si and O is a ratio including the microcrystalline Si or the amorphous Si. That is, SiOₓ includes one having a structure in which Si (e.g., microcrystalline Si) is dispersed in an amorphous SiO₂ matrix. In this case, the atomic ratio x, including the amorphous SiO₂ and the Si dispersed in the amorphous SiO₂, preferably satisfies 0.5≦x≦1.5. For example, as for a material having a structure in which Si is dispersed in an amorphous SiO₂ matrix and a molar ratio of SiO₂ to Si is 1:1, x is 1(x=1). Thus, this material can be expressed by the composition formula SiO. When the material having such a structure is analyzed by, for example, X-ray diffractometry, the peak resulting from the presence of Si (microcrystalline Si) may not be observed. But the presence of fine Si can be found when observing the material with a transmission electron microscope.

And SiOₓ is preferably a composite with a conductive material such as a carbon material, and the surface of SiOₓ is desirably coated with the conductive material (such as a carbon material), for example. SiOₓ is poor in conductivity. Thus, when using SiOₓ as the negative electrode active material, a conductive material (conductive assistant) is used to make the mixture and dispersion of SiOₓ and the conductive material in the negative electrode favorable and to form an excellent conductive network in terms of ensuring favorable battery characteristics. A composite obtained by combining SiOₓ and a conductive material allows the formation of a more favorable conductive network within the negative electrode than using a material obtained by simply mixing SiOₓ and a conductive material.

In addition to the composite in which the surface of SiOₓ is coated with a conductive material (preferably a carbon material) as described above, examples of a composite of SiOₓ and a conductive material include granules of SiOₓ and a conductive material (preferably a carbon material).

By further combining the composite in which the surface of SiOₓ is coated with a conductive material (preferably a carbon material) with a conductive material (carbon material, etc.), a more favorable conductive network can be formed within the negative electrode. Thus, it is possible to achieve a nonaqueous secondary battery having a higher capacity and favorable battery characteristics (e.g., charge/discharge cycle characteristic). Examples of a composite of a conductive material and SiO coated with a conductive material include granules obtained by further granulating a mixture of a conductive material and SiOₓ coated with a conductive material.

Further, as the aforementioned SiOₓ whose surface is coated with a conductive material, it is possible to use a composite (e.g., granules) of SiOₓ and a conductive material having a smaller specific resistance than the SiOₓ, and preferably granules of SiOₓ and a carbon material, the surface of which is further coated with a carbon material. When SiOₓ and the conductive material are being dispersed within the granules, a more favorable conductive network can be formed. Thus, for a nonaqueous secondary battery including a negative electrode containing the granules as the negative electrode material, its battery characteristics, such as a heavy load characteristic, can be improved further.

Preferred examples of the aforementioned conductive material that can be used in forming a composite with SiOₓ include carbon materials, such as graphite, low crystalline carbon, carbon nanotube and vapor phase epitaxy carbon fiber.

Specifically, the conductive material is preferably at least one material selected from the group consisting of a fibrous or coil-shaped carbon material, fibrous or coil-shaped metal, carbon black (including acetylene black and ketjen black), artificial graphite, easily graphitizable carbon and hardly graphitizable carbon. A fibrous or coil-shaped carbon material and fibrous or coil-shaped metal are preferable because they facilitate the formation of a conductive network and have a large surface area. Carbon black (including acetylene black and ketjen black), artificial graphite, easily graphitizable carbon and hardly graphitizable carbon are preferable because they have high electric conductivity and a high liquid-retaining property, and further they are likely to maintain contact with SiOₓ particles even if the particles expand/shrink due to charging/discharging of the battery.

Among the aforementioned conductive materials, a fibrous carbon material is particularly preferable to use when a composite with SiOₓ is in the form of granules. Since a fibrous carbon material has a thin thready shape and is highly flexible, it can respond to expansion/shrinkage of SiOₓ associated with charging/discharging of the battery. Further, since a fibrous carbon material has a large bulk density, it can have many contact points with SiOₓ particles. Examples of fibrous carbons include polyacrylonitrile (PAN) carbon fiber, pitch carbon fiber, vapor phase epitaxy carbon fiber, carbon nanotube, and the like, and any of these materials may be used.

A fibrous carbon material or fibrous metal also can be formed on the surface of SiOₓ particles by a vapor phase method, for example.

While the specific resistance of SiOₓ is normally 10³ to 10⁷ kωcm, the specific resistance of the aforementioned conductive materials is normally 10⁻⁵ to 10 kωcm.

A composite of SiOₓ and a conductive material may further include a material layer (e.g., a material layer including hardly graphitizable carbon) covering the carbon material coating layer on the surface of the particles.

When using a composite of SiOₓ and a conductive material in the negative electrode according to the present invention, the proportion of the conductive material is preferably 5 parts by mass or more, and more preferably 10 parts by mass or more to 100 parts by mass of SiOₓ in terms of favorably exhibiting the effects resulting from combining SiOₓ and the conductive material. Further, when the proportion of the conductive material combined with SiOₓ is too large in the composite, it may lead to a decrease in the amount of SiOₓ in the negative electrode active material containing layer, and an increase in the capacity may drop. Therefore, the proportion of the conductive material is preferably 50 parts by mass or less, and more preferably 40 parts by mass or less to 100 parts by mass of SiOₓ.

For example, the aforementioned composite of SiOₓ and a conductive material can be obtained as follows.

SiOₓ can be combined with itself. Thus, a production method when combining SiOₓ with itself will be described first. A dispersion solution is prepared by dispersing SiOₓ in a dispersion medium. The dispersion solution is sprayed and dried to produce composite particles including a plurality of particles. For example, ethanol can be used as the dispersion medium. Normally, it is suitable to spray the dispersion solution in an atmosphere at 50 to 300° C. In addition to the aforementioned method, similar composite particles can be produced by a mechanical granulation method using a vibration or planetary ball mill or rod mill.

When producing granules of SiOₓ and a conductive material having a specific resistance value lower than the SiOₓ, the conductive material is added to a dispersion solution prepared by dispersing the SiOₓ in a dispersion medium. By using this dispersion solution, composite particles (granules) are produced by the same technique as that used in combining SiOₓ itself. Further, granules of SiOₓ and a conductive material can be produced by the same mechanical granulation method as described above.

Next, when producing a composite by coating the surface of SiOₓ particles (SiOₓ composite particles or granulates of SiOₓ and a conductive material) with a carbon material, the SiOₓ particles and hydrocarbon gas are heated in a vapor phase, and carbon produced by the thermal decomposition of the hydrocarbon gas is deposited on the surface of the particles. In this way, by chemical-vapor deposition (CVD), it is possible to distribute the hydrocarbon gas throughout the composite particles and to form a thin and uniform film containing a conductive carbon material (carbon material coating layer) on the surface of the particles or holes in the surface. Thus, conductivity can be imparted to the SiOₓ particles using a small amount of carbon material.

A treatment temperature (atmospheric temperature) of the chemical-vapor deposition (CVD) in producing SiOₓ coated with a carbon material varies depending on the type of hydrocarbon gas being used. An appropriate temperature is normally in a range of 600 to 1200° C., and in particular, the temperature is preferably 700° C. or more, and more preferably 800° C. or more. This is because a higher treatment temperature results in less residual impurities and allows the formation of a coating layer containing carbon with a high degree of conductivity.

Although toluene, benzene, xylene, mesitylene or the like can be used as the liquid source of the hydrocarbon gas, toluene is particularly preferable because of its ease of handling. The hydrocarbon gas can be obtained by evaporating (e.g., by bubbling with nitrogen gas) any of these liquid sources. Further, methane gas or acetylene gas can also be used.

After coating the surface of the SiOₓ particles (SiOₓ composite particles or granules of SiOₓ and a conductive material) with the carbon material by chemical-vapor deposition (CVD), at least one organic compound selected from the group consisting of petroleum pitch, coal pitch, a thermosetting resin and a condensation product of naphthalene sulfonate and aldehydes is adhered to the coating layer containing a carbon material, and thereafter the particles to which the organic compound is adhered may be baked.

Specifically, a dispersion solution is prepared by dispersing the SiOₓ particles coated with the carbon material (SiOₓ composite particles or granules of SiOₓ and a conductive material) and the organic compound in a dispersion medium and the dispersion solution is sprayed and dried to form particles coated with the organic compound. Then, the particles coated with the organic compound are baked.

Isotropic pitch can be used as the pitch, and a phenol resin, furan resin or furfural resin can be used as the thermosetting resin. A naphthalene sulfonate-formaldehyde condensation product can be used as the condensation product of naphthalene sulfonate and aldehydes.

As the dispersion medium into which the SiOₓ particles coated with the carbon material and the organic compound are dispersed, for example, water or alcohols (e.g., ethanol) can be used. Normally, it is suitable to spray the dispersion solution in an atmosphere at 50 to 300° C. An appropriate baking temperature is normally in the range of 600 to 1200° C., and in particular, the temperature is preferably 700° C. or more, and more preferably 800° C. or more. This is because a higher treatment temperature results in less residual impurities and allows the formation of a coating layer containing a good-quality carbon material with a high degree of conductivity. However, the treatment temperature has to be equal to or less than the melting point of SiOₓ.

In addition to using the aforementioned negative electrode active material to increase the capacity, the nonaqueous secondary battery of the present invention adopts the following configuration (1) or (2) to suppress deformations resulting from expansion of the negative electrode active material associated with charging, such as a change in the volume and curving of the negative electrode.

In the configuration (1), the 0.2% proof stress of the negative electrode current collector is 250 N/mm² or more, preferably 300 N/mm² or more. The 0.2% proof stress of the negative electrode current collector in this specification refers to “Fe”, which can be determined as follows. Using a “Compact Table-top Universal Tester EZ-L” (manufactured by Shimazu Corp.), a negative electrode current collector as a measuring sample cut into a size of 160 mm×25 mm is subjected to a tensile test at a tensile rate of 2 mm/min and at a temperature of 20° C. to determine the stress-distortion curve. From the stress-distortion curve, Fe is determined as the value of the stress where the permanent tension becomes 0.2% in accordance with an “offset method” defined in section “8. (d)” of Japanese Industrial Standards (JIS) Z 2241.

Further, in the configuration (2), the tensile strength of the negative electrode current collector is 300 N/mm² or more, preferably 350 N/mm² or more. In this specification, the tensile strength of the negative electrode current collector refers to a value determined by measuring a negative electrode current collector as a measuring sample cut into a size of 160 mm×25 mm, using a “Compact Table-top Universal Tester EZ-L” (manufactured by Shimazu Corp.) at a tensile rate of 2 mm/min and at a temperature of 20° C.

To increase the 0.2% proof stress or tensile strength of the negative electrode current collector as described above, it is preferable to use a current collector (current collector foil) made of a Cu alloy including at least one element selected from the group consisting of Zr, Cr, Sn, Zn, Ni, Si and P as the negative electrode current collector. By using a Cu alloy including any of such elements, it is possible to form a current collector having a large 0.2% proof stress or tensile strength as described above.

More preferred compositions of the Cu alloy include Cu—Cr, Cu—Ni, Cu—Cr—Zn and Cu—Ni—Si. The amount of alloy components other than Cu in the Cu alloy is preferably 0.01 to 5 mass % (in this case, the remainder is, for example, Cu and unavoidable impurities).

For a Cu—Cr—Zn alloy, the content of Cr is preferably 0.05 to 0.5 mass % and the content of Zr is preferably 0.01 to 0.3 mass %. As needed, a Cu—Cr—Zn alloy may include an element such as Mg, Zn, Sn or P within the preferred content range of the alloy components described above.

Further, examples of Cu—Ni—Si alloys include a Corson alloy. In this case, the content of Ni is preferably 1.0 to 4.0 mass % and the content of Si is preferably 0.1 to 1.0 mass %. As needed, a Cu—Ni—Si alloy may include an element such as Mg, Zn, Sn or P within the preferred content range of the alloy components described above.

In terms of extending the range of resilience of and increasing the strength of the negative electrode current collector, the thickness of the negative electrode current collector is preferably 6 μm or more, and more preferably 8 μm or more. However, when the negative electrode current collector is too thick, the proportion of volume of the negative electrode current collector, which does not involve directly in a power generation reaction, increases in the battery, and the amount of active materials in the positive and negative electrodes decreases. Thus, an increase in the capacity resulting from the use of the negative electrode active material may drop. Thus, the thickness of the negative electrode current collector is preferably 16 μm or less, and more preferably 14 μm or less.

With regard to the 0.2% proof stress and the tensile strength of the negative electrode current collector, it is difficult to make a Cu alloy foil with an extremely large 0.2% proof stress and tensile strength have a thickness of 16 μm or less. And as described above, when a current collector with such a thickness is used, an increase in the capacity resulting from the use of the aforementioned negative electrode active material may drop. Thus, the 0.2% proof stress of the negative electrode current collector is preferably 750 N/mm² or less, and more preferably 700 N/mm² or less. Further, the tensile strength of the negative electrode current collector is preferably 800 N/mm² or less, and more preferably 750 N/mm² or less.

From Cu alloy foils having the aforementioned compositions and thickness, one having the 0.2% proof stress or tensile strength as described above may be selected and used as the negative electrode current collector. A rolled foil obtained by rolling can be preferably used as the negative electrode current collector because it is likely to have a large tensile strength.

The negative electrode according to the present invention has such a structure that negative electrode active material containing layers containing the negative electrode active material are formed on one side or both sides of the negative electrode current collector as described above. An appropriate solvent (dispersion medium) is added to a negative electrode mixture including a binder and a conductive material (including the conductive material used in forming a composite with the negative electrode active material) used as needed in addition to the aforementioned negative electrode active material, and they are mixed thoroughly to obtain a composition (coating) in the form of paste or slurry. The composition is applied to the current collector, followed by removal of the solvent (dispersion medium) by drying, and thus the negative electrode active material containing layers are formed in certain thickness and density.

In the nonaqueous secondary battery of the present invention, in conjunction with the use of the negative electrode current collector having a 0.2% proof stress or tensile strength in the aforementioned value, at least one of polyimide, polyamideimide and polyamide is used as a binder in the negative electrode active material containing layers or a porous layer (coating layer) containing an insulating material not reactive with Li is formed on a surface of each negative electrode active material containing layer opposite to the side facing the negative electrode current collector. Thus, deformations resulting from expansion of the negative electrode active material at the time of charging, such as a change in the volume and curving of the negative electrode, are suppressed so as to prevent deterioration of the charge/discharge cycle characteristic and battery swelling.

Therefore, when the negative electrode of the battery of the present invention does not include the aforementioned coating layers, at least one of polyimide, polyamideimide and polyamide needs to be used as a binder in the negative electrode active material containing layers. On the other hand, when the negative electrode of the battery of the present invention includes the aforementioned coating layers, a binder for the negative electrode active material containing layers is not particularly limited. However, it is preferable to use at least one of polyimide, polyamideimide and polyamide as the binder.

Polyimide, polyamideimide and polyamide strongly bond a variety of components (bonding the negative electrode active material together, the negative electrode active material and a conductive material (described later) together, and composites including the negative electrode active material together) of the negative electrode active material containing layer together. Thus, by using any of these as the binder in the negative electrode active material containing layers, even if the negative electrode active material expands/shrinks as the battery being charged/discharged repeatedly, contacts between the components can be maintained and a conductive network within the negative electrode active material containing layer can be retained favorably.

Examples of polyimide include a variety of well-known polyimides, and any of thermoplastic polyimide and thermosetting polyimide can be used. Further, thermoplastic polyimide may be either condensed polyimide or adduct polyimide. More specifically, it is possible to use any of commercially available products such as “SEMICOFINE” (trade name) manufactured by Toray Co., Ltd., “PIX SERIES” (trade name) manufactured by HD Micro Systems, Ltd., “HCI SERIES” (trade name) manufactured by Hitachi Chemicals Co., Ltd., and “U-VARNISH” (trade name) manufactured by Ube Industries, Ltd. Polyimide having an aromatic ring in its molecular chain, in other words, aromatic polyimide is more preferable because of having favorable electron movability. Polyimide may be used alone or in combination of two or more.

Examples of polyamideimide include a variety of well-known polyamideimides. More specifically, any of commercially available products such as “HPC SERIES” (trade name) manufactured by Hitachi Chemicals Co., Ltd. and “BIROMAX” (trade name) manufactured by TOYOBO Co., LTD. Also for polyamideimide, one having an aromatic ring in its molecular chain, in other words, aromatic polyamideimide is more preferable because of the same reason as polyimide. Polyamideimide may be used alone or in combination of two or more.

A variety of polyamides such as Nylon 66, Nylon 6 and aromatic polyamide (e.g., Nylon MXD6) can be used as polyamide. Also for polyamide, one having an aromatic ring in its molecular chain, in other words, aromatic polyamide is more preferable because of the same reason as polyimide. Polyamide may be used alone or in combination of two or more kinds.

Polyimide, polyamideimide and polyamide may be used in combination of two or more as a binder in the negative electrode active material containing layers.

Binders other than polyimide, polyamideimide and polyamide can be used in the negative electrode active material containing layers. Examples of such binders include: polysaccharides such as starch, polyvinyl alcohol, carboxymethyl cellulose, hydroxypropyl cellulose, regenerated cellulose and diacetyl cellulose and modified forms of these polysaccharides; thermoplastic resins such as polyvinyl chloride, polyvinyl pyrrolidone, polytetrafluoroethylene, polyvinylidene fluoride, polyethylene and polypropylene and modified forms of these thermoplastic resins; elastically resilient polymers such as ethylene-propylene-dieneter polymer (EPDM), sulfonated EPDM, styrene butadiene rubber, butadiene rubber, polybutadiene, fluorocarbon rubber and polyethylene oxide and modified forms of these elastically resilient polymers. They may be used alone or in any combination of two or more. Any of these binders other than polyimide, polyamideimide and polyamide can be used in combination with any of polyimide, polyamideimide and polyamide when the negative electrode according to the present invention does not include the coating layers. Further, although any of these binders other than polyimide, polyamideimide and polyamide does not have to be used in combination with any of polyimide, polyamideimide and polyamide when the negative electrode according to the present invention includes the coating layers, they are preferably used in combination with any of polyimide, polyamideimide and polyamide.

A conductive material may be further added to the negative electrode active material containing layers as a conductive assistant. Such a conductive material is not particularly limited as long as it is an electron conductive material that does not chemically react in the nonaqueous secondary battery. Normally, materials such as natural graphite (vein graphite, flake graphite, amorphous graphite, etc.), artificial graphite, carbon black, acetylene black, ketjen black, carbon fiber, metal powder (copper powder, nickel powder, aluminum powder, silver powder, etc.), metal fiber, a polyphenylene derivative (one described in JP S59-20971 A) can be used alone or in combination of two or more.

Further, the negative electrode active material containing layers may be formed by methods other than that described above. For example, when using a simple substance that can be alloyed with Li or an alloy containing an element that can be alloyed with Li as the negative electrode active material, films of the negative electrode active material are formed on the surface of the negative electrode current collector by a film forming method, such as physical vapor deposition (PVD), chemical vapor deposition (CVD) or liquid phase epitaxy, and the films may be used as the negative electrode active material containing layers. Examples of PVD include vacuum deposition, spattering, ion plating, molecular beam epitaxy (MBE), and laser aberration. Examples of CVD include thermal CVD, MOCVD (metal organic chemical vapor deposition), RF (radio frequency) plasma CVD, ECR (electron cyclotron resonance) plasma CVD, optical CVD, laser CVD, and atomic layer epitaxy (ALE). Further, examples of liquid phase epitaxy include platings (electro plating, electroless plating), anodic oxidation, coating and sol-gel.

Further, when using, for example, Cu₆Sn₅ as the alloy (intermetallic compound) containing an element that can be alloyed with Li, Cu₆Sn₅ may be formed by laminating Cu films and Sn films in alternate order by any of the various film forming methods and subjecting them to a heat treatment to disperse Cu and Sn mutually.

In terms of increasing the capacity of the battery, the content of the negative electrode active material in the negative electrode active material containing layers is preferably 60 mass % or more, and more preferably 70 mass % or more. The negative electrode active material containing layers may be composed solely of the negative electrode active material, or films made of a simple substance that can be alloyed with Li or an alloy including an element that can be alloyed with Li may be used as the negative electrode active material containing layers as described above. Therefore, the content of the negative electrode active material in the negative electrode active material containing layers may be 100 mass %, but when a binder is used in combination with the negative electrode active material in forming the negative electrode active material containing layers, the content of the negative electrode active material is preferably 99 mass % or less, and more preferably 98 mass % or less in terms of ensuring the effects resulting from the use of the binder.

Further, in terms of exhibiting the effects resulting from the use of the binder more effectively, the content of the binder in the negative electrode active material containing layers is preferably 1 mass % or more, and more preferably 2 mass % or more. However, when the amount of the binder in the negative electrode active material containing layers is too large, the amount of the negative electrode active material becomes small, which may lead to a decline in the capacity. Therefore, the content of the binder in the negative electrode active material containing layers is preferably 30 mass % or less, and more preferably 20 mass % or less.

When using at least one of polyimide, polyamideimide and polyamide as a binder in the negative electrode active material containing layers in combination with other binders, the content of polyimide, polyamideimide and polyamide (when using only one of these, the content is of the one to be used, and when using two or more of these, the content is a total of the ones to be used) is preferably 1 mass % or more, and more preferably 2 mass % or more and they are desirably adjusted to satisfy the preferred amount of the binders as described above. By adjusting the content of polyimide, polyamideimide and/or polyamide in the negative electrode active material containing layers as described above, it is possible to exhibit the effects resulting from the use of these binders more effectively.

When using conductive materials (including a conductive assistant, carbon with which the surface of the oxide is coated, a conductive material forming a composite with the oxide whose surface is coated with carbon, and a conductive material forming granules with the oxide whose surface is coated with carbon) in forming the negative electrode active material containing layer, the total amount of the conductive materials is preferably 50 mass % or less, and more preferably 40 mass % or less in terms of increasing the capacity of the battery further. Also, in terms of exhibiting of the effects resulting from the use of the conductive materials in the negative electrode active material containing layer more effectively, the total amount of the conductive materials in the negative electrode active material containing layers is preferably 5 mass % or more, and more preferably 10 mass % or more.

The thickness of the negative electrode active material containing layers (the thickness on each side of the current collector, the same applies also in the following) varies depending on the composition of the negative electrode active material containing layers and the method by which the negative electrode active material containing layers are formed. In terms of reducing the hardness of the negative electrode to a certain degree, the thickness is preferably 50 μm or less, and more preferably 30 μm or less when the negative electrode active material containing layers are made using a negative electrode mixture (e.g., a case of the negative electrode active material containing layers that are formed using the aforementioned composition for forming the negative electrode active material containing layer, and the same applies also in the following). On the other hand, when the negative electrode active material containing layers are made using films of the negative electrode active material as described above, the thickness is preferably 20 μm or less, and more preferably 10 μm or less. However, when the negative electrode active material containing layers are too thin, an increase in the capacity of the battery may drop. Therefore, the thickness of the negative electrode active material containing layers are preferably 5 μm or more, and more preferably 10 μm or more when the negative electrode active material containing layers are made using a negative electrode mixture. On the other hand, when the negative electrode active material containing layers are made using films of the negative electrode active material as described above, the thickness is preferably 1 μm or more, and more preferably 3 μm or more.

As described above, when at least one of polyimide, polyamideimide and polyamide is not used as a binder in the negative electrode active material containing layers, a porous layer (coating layer) containing an insulating material not reactive with Li is formed on the surface (opposite to the surface facing the negative electrode current collector) of each negative electrode active material containing layer. By using the negative electrode current collector having a large 0.2% proof stress or tensile strength as described above and further forming the coating layer, deformations such as a change in the volume and curving of the negative electrode can be suppressed favorably, so that it is possible to prevent the deterioration of the charge/discharge cycle characteristic of the nonaqueous secondary battery and to reduce battery swelling favorably. As describe above, even if the negative electrode includes the coating layers, at least one of polyimide, polyamideimide and polyamide is preferably used as a binder in the negative electrode active material containing layer.

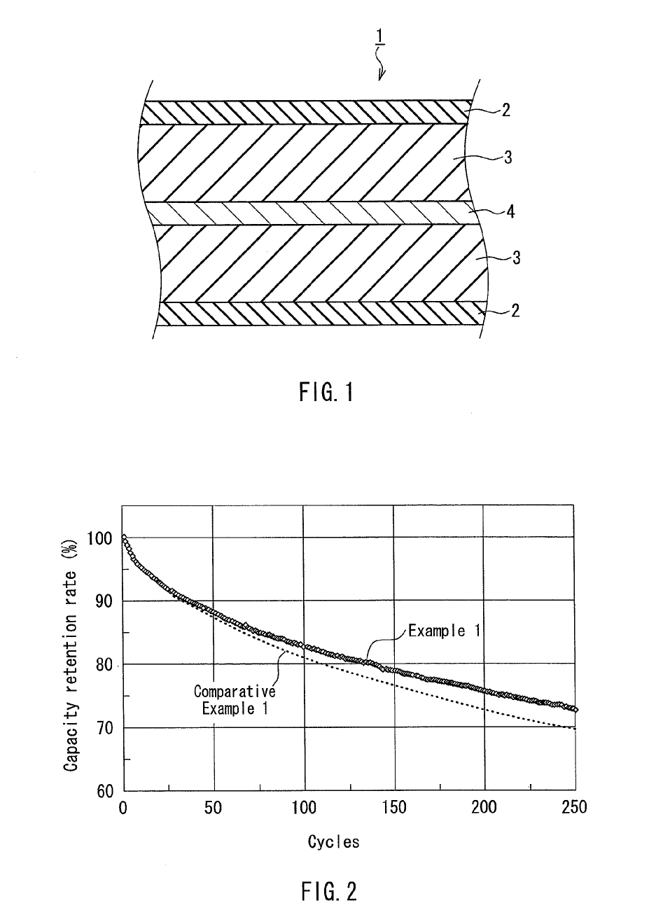

FIG. 1 is a schematic cross-sectional view showing an example of a negative electrode including coating layers. A negative electrode 1 has such a structure that coating layers 2 are each laminated on the surface of negative electrode active material containing layers 3 containing a negative electrode active material including an element that can be alloyed with Li. In FIG. 1, reference numeral 4 denotes a negative electrode current collector.

Each of the coating layers of the negative electrode contains an insulating material not reactive with Li and is a layer with pores (porous layer) through which a nonaqueous electrolyte (electrolytic solution) can pass through.

The insulating material not reactive with Li and used for forming the coating layers is preferably electro-chemically stable and electrically insulating fine particles. Although there is no particular limitation as long as such particles are used, organic fine particles are more preferable. Specific examples include the following: fine particles of inorganic oxides such as iron oxide, silica (SiO₂), alumina (Al₂O₃), TiO₂, and BaTiO₃; fine particles of inorganic nitrides such as aluminum nitride and silicon nitride; fine particles of hardly-soluble ionic crystals such as calcium fluoride, barium fluoride and barium sulfate; fine particles of covalent crystals such as silicon and diamond. The inorganic oxide fine particles may be those derived from the mineral resources such as boehmite, zeolite, apatite, kaoline, mullite, spinel, olivine and mica or artificial products of these materials. Moreover, the inorganic fine particles may be electrically insulating fine particles obtained by coating the surface of a conductive oxide such as metal, SnO₂ or indium tin oxide (ITO); or a carbonaceous material such as carbon black or graphite with a material having electrical insulation (e.g., any of the aforementioned inorganic oxides).

Organic fine particles can also be used as the insulating material not reactive with Li. Specific examples of organic fine particles include the following: fine particles of cross-linked polymers such as polyimide, a melamine resin, a phenol resin, cross-linked polymethyl methacrylate (cross-linked PMMA), cross-linked polystyrene (cross-linked PS), polydivinylbenzene (PDVB), and a benzoguanamine-formaldehyde condensation product; and fine particles of heat-resistant polymers such as thermoplastic polyimide. The organic resin (polymer) constituting any of these organic fine particles may be a mixture, a modified product, a derivative, a copolymer (a random copolymer, an alternating copolymer, a block copolymer, or a graft copolymer), or a cross-linked product (in the case of the heat-resistant polymer) of the aforementioned polymeric materials.

The aforementioned fine particles may be used alone or in combination of two or more. Among the aforementioned fine particles, fine particles of inorganic particles are more preferable, and alumina, silica, and boehmite are even more preferable.

As the fine particles, it is preferable to use those with the proportion of particles having a particle size of 0.2 μm or less and the proportion of particles having a particle size of 2 μm or more each being 10 vol % or less and having a narrow particle size distribution and a uniform particle size. Consequently, it is possible to form coating layers that are thin but highly effective in preventing a change in volume and curving of the negative electrode.

The particle size of the fine particles can be determined from a volume-based particle size distribution that is measured with a laser diffraction particle size analyzer (e.g., “LA-920” manufactured by Horiba, Ltd.) by dispersing the fine particles in a medium (e.g., water), in which the fine particles do not swell or dissolve. That is, when the value of 10% of a volume-based accumulated percentage (d10) is 0.2 μm or more, it means that the proportion of particles having a particle size of 0.2 μm or less is 10 vol % or less, and when the value of 90% of a volume-based accumulated percentage (d90) is 2 μm or less, it means that the proportion of particles having a particle size of 2 μm or more is 10 vol % or less. Thus, those having such a particle distribution may be used as the fine particles.

Further, an electron conductive material may be included in the coating layer. Although an electron conductive material is not an essential component of the coating layers, as will be described later, an electron conductive material is included in the coating layers when Li is pre-introduced into the negative electrode active material.

Examples of electron conductive materials that can be used in the coating layers include: carbon materials such as carbon particles and carbon fiber; metal materials such as metal particles and metal fiber; and metal oxides, among which carbon particles and metal particles are preferred because they have low reactivity with Li.

Any known carbon materials that have been used as conductive assistants in electrodes constituting batterys can be used as the carbon material. Specific examples include carbon particles such as carbon black (thermal black, furnace black, channel black, lamp black, ketjen black, acetylene black, etc.), graphite (natural graphite such as flake graphite and amorphous graphite and artificial graphite) and carbon fiber.

Among the carbon materials mentioned above, the combined use of carbon black and graphite is particularly preferable in terms of dispersibility with a binder (described later). As the carbon black, ketjen black or acetylene black is particularly preferable.

The particle size of the carbon particles is preferably 0.01 μm or more and 10 μm or less, and more preferably 0.02 μm or more and 5 μm or less.

Metal particles or metal fibers usable as the electron conductive material for forming the coating layers preferably are composed of a metal element that has a low degree of reactivity with Li and resistant to alloying with Li. Specific examples of metal elements constituting the metal particles or metal fibers include Ti, Fe, Ni, Cu, Mo, Ta and W.

The form of metal particles is not particularly limited and may be any shape such as a cluster shape, needle-like shape, columnar shape or plate-like shape. It is preferable that the surface of metal particles or metal fiber is not excessively oxidized. If the surface of the metal particles or metal fiber is excessively oxidized, the metal particles or metal fiber is desirably subjected to a heat treatment in advance in a reducing atmosphere to be used in forming the coating layers.

The particle size of metal particles is preferably 0.02 μm or more and 10 μm or less, and more preferably 0.1 μm or more and 5 μm or less.

When forming the coating layers, a binder is preferably used for binding the insulating material not reactive with Li together, and any of the various materials mentioned above as a binder in the negative electrode active material containing layers can be used. It is preferable that the same binder is used in the coating layers and the negative electrode active material containing layers (e.g., using at least one of polyimide, polyamideimide and polyamide as the binder in the coating layers as well as the negative electrode active material containing layers) because the bonding between each negative electrode active material containing layer and each coating layer improves.

When using a binder in forming the coating layers, the content of the binder in the coating layers is preferably 2 mass % or more and 60 mass % or less, and more preferably 4 mass % or more and 50 mass % or less.

In a case where an electron conductive material is included in the coating layers, the proportion of the electron conductive material is preferably 2.5 mass % or more and 96 mass % or less, and more preferably 5 mass % or more and 95 mass % or less, for example, when the total mass of the insulating material not reactive with Li and the electron conductive material is assumed to be 100 mass %. In other words, the proportion of the insulating material not reactive with Li is preferably 4 mass % or more and 97.5 mass % or less, and more preferably 5 mass % or more and 95 mass % or less, for example.

The thickness of the coating layers is preferably 1 μm or more and 10 μm or less, more preferably 2 μm or more and 8 μm or less, and particularly preferably 3 μm or more and 6 μm or less. As long as the coating layers have such a thickness, deformations such as a change in volume and curving of the negative electrode can be suppressed more effectively, and an increase in the capacity of the battery, prevention of deterioration of the charge/discharge cycle characteristic and reduction of battery swelling can be achieved more favorably. When the thickness of the coating layers is too small relative to the surface roughness of the negative electrode active material containing layers, it is difficult to cover the entire surface of the negative electrode active material containing layers without creating pinholes, and the effects resulting from forming the coating layers may be weakened. On the other hand, when the coating layers are too thick, it leads to a drop in the capacity of the battery. Therefore, it is preferable to form the coating layers as thin as possible.

As described above, by using fine particles having a uniform particle size as the insulating material not reactive with Li, the coating layers having favorable properties and not including pinholes or the like can be formed easily while minimizing the thickness as described above.

Further, since the affinity between the negative electrode and a nonaqueous electrolyte improves by providing the coating layers, a nonaqueous electrolyte can be easily introduced into the battery.

The coating layers can be formed as follows. A mixture containing the aforementioned insulating material not reactive with Li and an electron conductive material and a binder used as needed is thoroughly mixed with an appropriate solvent (dispersion medium) to obtain a composition (coating) in the form of paste or slurry. The coating is applied to the surface of the negative electrode active material containing layers formed on the surface of the negative electrode current collector, followed by removal of the solvent (dispersion medium) by drying, and thus the coating layers are formed in predetermined thickness. The coating layers may be formed by methods other than that mentioned above. For example, after applying the composition for forming a negative electrode active material containing layer to the surface of a current collector, the composition for forming a coating layer is applied onto the composition for forming a negative electrode active material containing layer before the coating dries up completely, followed by drying to form the negative electrode active material containing layers and the coating layers at the same time. Furthermore, in addition to the aforementioned successive method in which the composition for forming a negative electrode active material containing layer and the composition for forming a coating layer are applied by turns, the negative electrode active material containing layers and the coating layers can be formed at the same time by a simultaneous application method in which the composition for forming a negative electrode active material containing layer and the composition for forming a coating layer are applied at the same time.

The aforementioned negative electrode active material (e.g., SiOₓ) used in the negative electrode according to the present invention has a relatively large irreversible capacity. Thus, Li is preferably pre-introduced into the negative electrode according to the present invention. In this case, the capacity can be increased further.

As a method of introducing Li into the negative electrode, it is preferable that an Li-containing layer is formed on the surface of each coating layer (coating layer also containing an electron conductive material) opposite to the side facing the negative electrode active material containing layer to introduce Li from the Li-containing layers into the negative electrode active material in the negative electrode active material containing layers.

When Li is introduced into the negative electrode active material, curving of the negative electrode may occur due to a change in the volume of the negative electrode active material. However, if the coating layers are formed in the negative electrode, Li in the Li-containing layers is electrochemically introduced into the negative electrode active material in the negative electrode active material containing layers in an environment where a nonaqueous electrolyte (electrolytic solution) included in the battery is present (e.g., inside the battery) but Li is hardly introduced into the negative electrode active material in an environment where a nonaqueous electrolyte is not present. In this way, when adopting the aforementioned Li introduction method, the coating layers of the negative electrode also function to supply Li in the Li-containing layers to the negative electrode active material containing layers through the nonaqueous electrolyte. Consequently, by controlling the reactivity between the negative electrode active material and Li, curving of the negative electrode associated with the introduction of Li can be suppressed.

It is preferable that the Li-containing layers for introducing Li into the negative electrode are layers formed by a general vapor phase method (vapor deposition) such as resistance heating or spattering (i.e., evaporated film). By directly forming the Li-containing layers on the surface of the coating layers as evaporated films by a vapor phase method, uniform layers can be formed throughout the coating layers in a desired thickness with ease. Thus, an adequate amount of Li necessary to compensate the irreversible capacity of the negative electrode active material can be introduced.

When forming the Li-containing layers by a vapor phase method, an evaporation source and the coating layers according to the negative electrode may be brought to face each other in a vacuum chamber and the Li-containing layers are evaporated on the coating layers until they obtain a predetermined thickness.

The Li-containing layers may be composed solely of Li or of an Li alloy such as Li—Al, Li—Al—Mn, Li—Al—Mg, Li—Al—Sn, Li—Al—In or Li—Al—Cd. When the Li-containing layers are composed of an Li alloy, the percentage of content of Li in the Li-containing layers is preferably 50 to 90 mol %, for example.

The thickness of the Li-containing layers is preferably 2 μm or more and 10 μm or less, and more preferably 4 μm or more and 8 μm or less, for example. By forming the Li-containing layers in such a thickness, an adequate amount of Li necessary to compensate the irreversible capacity of the negative electrode active material can be introduced. In other words, when the Li-containing layers are too thin, the amount of Li becomes small relative to the amount of the negative electrode active material present in the negative electrode active material containing layers, and an increase in the capacity resulting from pre-introducing Li into the negative electrode may drop. Conversely, when the Li-containing layers are too thick, the amount of Li may become excessive. Also the evaporation amount increases, so that the productivity drops.

The positive electrode according to the present invention can be obtained as follows. A mixture (positive electrode mixture) containing a positive electrode active material, a conductive assistant and a binder is thoroughly mixed with an appropriate solvent (dispersion medium) to obtain a positive electrode mixture containing composition in the form of paste or slurry. The composition is applied to a positive electrode active current collector to form positive electrode active material containing layers having certain thickness and density. The method for producing the positive electrode according to the present invention is not limited to the one described above and the positive electrode may be produced by other methods.

Examples of positive electrode active materials include Li-containing transition metal oxides having a layered structure, such as Li_{y}CoO₂ (where 0≦y≦1.1), Li_{z}NiO₂ (where 0≦z≦1.1), LiₑMnO₂ (where 0≦e≦1.1), LiₐCo_{b}M¹_{1-b}O₂ (where M¹ is at least one metal element selected from the group consisting of Mg, Mn, Fe, Ni, Cu, Zn, Al, Ti, Ge and Cr, 0≦a<1.1, and 0≦b≦1.0), Li_{c}Ni_{1-d}M²_{d}O² (where M² is at least one metal element selected from the group consisting of Mg, Mn, Fe, Co, Cu, Zn, Al, Ti, Ge and Cr, 0≦c≦1.1, and 0≦d≦1.0), and Li_{f}Mn_{g}NiₕCo_{1-g-h}O₂ (where 0≦f≦1.1, 0≦g≦1.0, and 0≦h≦1.0). They may be used alone or in combination of two or more.

Any of the aforementioned binders for the negative electrode can also be used for the positive electrode. Further, any of the aforementioned conductive assistants for the negative electrode can also be used for the positive electrode.

In the positive electrode active material containing layers of the positive electrode, it is preferable that the content of the positive electrode active material is, for example, 80 to 99 mass %, the content of a binder is, for example, 0.5 to 20 mass % and the content of a conductive assistant is, for example, 0.5 to 20 mass %.

A nonaqueous electrolyte to be used in the battery according to the present invention may be an electrolytic solution prepared by dissolving any of the following inorganic ion salts in any of the following solvents.

As the solvent, it is possible to use any of aprotic organic solvents, such as ethylene carbonate (EC), propylene carbonate (PC), butylene carbonate (BC), dimethyl carbonate, diethyl carbonate (DEC), methyl ethyl carbonate (MEC), γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric triester, trimethoxymethane, dioxolane derivative, sulfolane, 3-methyl-2-oxazolidinone, propylene carbonate derivative, tetrahydrofuran derivative, diethyl ether and 1,3-propanesulton. They can be used alone or in combination of two or more.

As the inorganic ion salt, Li salts such as LiClO₄, LiBF₄, LiPF₆, LiCF₃SO₃, LiCF₃CO₂, LiAsF₆, LiSbF₆, LiB_{1.0}Cl_{1.0}, lithium lower aliphatic carboxylate, LiAlCl₄, LiCl, LiBr, LiI, lithium chloroborate and lithium tetraphenylborate can be used alone or in combination of two or more.

Among electrolytic solutions prepared by dissolving any of the aforementioned inorganic ion salts in any of the aforementioned solvents, an electrolytic solution prepared by dissolving at least one inorganic ion salt selected from the group consisting of LiClO₄, LiBF₄, LiPF₆, and LiCF₃SO₃ in a solvent containing ethylene carbonate or propylene carbonate and at least one selected from the group consisting of 1,2-dimethoxyethane, diethyl carbonate and methyl ethyl carbonate is preferable. An appropriate concentration of the inorganic ion salt in the electrolytic solution is 0.2 to 3.0 mol/dm³, for example.

The nonaqueous secondary battery of the present invention can be obtained by assembling the battery using components such as the negative electrode, the positive electrode and the nonaqueous electrolyte described above.

As long as the nonaqueous secondary battery of the present invention includes the negative electrode, the positive electrode and the nonaqueous electrolyte described above, there is no particular limitation to other components or the structure of the battery. A variety of conventionally-known components and structures that have been adopted by nonaqueous secondary batteries can be applied to the nonaqueous secondary battery of the present invention.

For example, as a separator, one having sufficient strength and capable of retaining a large amount of electrolytic solution is preferable. From this point of view, a microporous film or non-woven fabric containing polyethylene, polypropylene or an ethylene-propylene copolymer and having a thickness of 10 to 50 μm and a porosity of 30 to 70% is preferable.

There is also no particular limitation to the shape of the nonaqueous secondary battery of the present invention. For example, it may have any of the following shapes; a coin shape, a button shape, a sheet shape, a laminate type, a cylindrical shape, a flat shape, a rectangular shape and a large type as used for electric vehicles and the like. As described above, when the aforementioned negative electrode active material is used in a battery including a rectangular (rectangular cylinder) outer can or a flat outer can having a small thickness relative to the width or a laminate film outer package, battery swelling is particularly likely to occur. Since the occurrence of such battery swelling can be suppressed favorably in the battery of the present invention, its effects are manifested noticeably when the battery is in the form of rectangular battery or flat-shaped battery having the outer package (outer can) as described above.

Further, depending on the form of the nonaqueous secondary battery, the positive electrode, the negative electrode and a separator can be introduced into the battery in the form of a laminated electrode body obtained by laminating a plurality of the positive electrodes and a plurality of the negative electrodes via a separator or a wound electrode body obtained by laminating the positive electrode and the negative electrode via a separator and further winding the laminate spirally. As described above, when the aforementioned negative electrode active material is used, problems resulting from deformations such as a change in the volume and curving of the negative electrode are particularly likely to occur when a wound electrode body is used. In the battery of the present invention, however, deformations such as a change in the volume and curving of the negative electrode can be suppressed favorably. Thus, the effects of the battery are manifested noticeably when the battery includes a wound electrode body (particularly, a wound electrode body whose cross-section perpendicular to a winding axis is flat and used for a rectangular battery or a flat-shaped battery using a flat-shaped outer can or a laminate film outer package).

The nonaqueous secondary battery of the present invention has a high capacity and a variety of favorable battery characteristics including a charge/discharge cycle characteristic. Thus, by making full use of these characteristics, the nonaqueous secondary battery of the present invention can be preferably used in a variety of applications to which conventionally-known nonaqueous secondary batteries have been applied, including a power source for a small and multifunctional mobile device.

### EXAMPLES

Hereinafter, the present invention will be described in detail by way of Examples. Nevertheless, the present invention is not limited to the following Examples. In the following Examples, an average particle size of each of various composite particles, α-alumina and graphite is a volume average measured by a laser diffraction particle distribution measurement method using “MICROTRAC HRA (Model: 9320-X100) manufactured by MICROTRAC Co., Ltd. Further, the 0.2% proof stress and the tensile strength of each negative electrode current collector are values measured respectively by the aforementioned methods.

### Example 1

SiO (average particle size: 5.0 μm) was heated to about 1000° C. in an ebullated bed reactor and brought into contact with mixed gas of methane and nitrogen gas having a temperature of 25° C., and they were subjected to a CVD treatment at 1000° C. for 60 minutes. In this way, the carbon (hereinafter also referred to as “CVD carbon”) produced by the thermal decomposition of the mixed gas was deposited on the SiO to form a coating layer, and thus a negative electrode material (negative electrode active material) was obtained.

The composition of the negative electrode material was determined by calculating a change in the mass before and after the formation of the coating layer and found that the ratio of SiO to CVD carbon was 90:10 (mass ratio).

Next, a negative electrode was produced using the negative electrode material. 80 mass % (the content in the total amount of solids, the same applies also in the following) of the negative electrode material, 10 mass % of graphite, 2 mass % of ketjen black (average particle size: 0.05 μm) as a conductive assistant, 8 mass % of polyamideimide (“HPC-9000-21” manufactured by Hitachi Chemicals Co., Ltd) as a binder, and dehydrated N-methyl pyrrolidone (NMP) were mixed to prepare a negative electrode mixture containing slurry. Further, 95 mass % (the content in the total amount of solids, the same applies also in the following) of α-alumina (average particle size: 1 μm, d10: 0.64 μm, d90: 1.55 μm, the proportion of particles having a particle size of 0.2 μm or less and the proportion of particles having a particle size of 2 μm or more are both 10 vol. % or less), 5 mass % of polyvinylidene fluoride (PVDF) and dehydrated NMP were mixed to prepare a slurry for forming a coating layer.

With a blade coater, the negative electrode mixture containing slurry and the slurry for forming a coating layer were applied, as a lower layer and a upper layer, respectively, onto both sides of a current collector made of a high-strength copper foil (“HCL-02Z” produced by Hitachi Cable, Ltd., 0.2% proof stress: 270 N/mm², tensile strength: 350 N/mm²) having a thickness of 10 μm. After drying the applied slurries at 100° C., they were compression molded by a roller press so as to form negative electrode active material containing layers each having a thickness of 35 μm and coating layers each having a thickness of 5 μm on the current collector, and thus a laminate was produced. The laminate obtained by forming the negative electrode active material containing layers and the coating layers on the surfaces of the current collector was dried in a vacuum at 100° C. for 15 hours.

The dried laminate was further subjected to a heat treatment at 160° C. for 15 hours using a far-infrared heater. With regard to the laminate after the heat treatment, the bonding between the current collector and the negative electrode active material containing layers and the bonding between each negative electrode active material containing layer and each coating layer were strong. Thus, even when the laminate was cut or bent, the negative electrode active material containing layers did not peel off from the current collector and the coating layers also did not peel off from the negative electrode active material containing layers.

The laminate was cut to obtain a strip-shaped negative electrode having a width of 37 mm.

Further, a positive electrode was produced as follows. First, 96 mass % (the content in the total amount of solids, the same applies also in the following) of LiCoO₂ as a positive electrode material (positive electrode active material), 2 mass % of ketjen black (average particle size: 0.05 μm) as a conductive assistant, 2 mass % of PVDF as a binder and dehydrated NMP were mixed to obtain a positive electrode mixture containing slurry. The slurry was then applied onto both sides of a current collector made of an aluminum foil having a thickness of 15 μm. After being dried, the applied slurry was pressed to form positive electrode active material containing layers each having a thickness of 85 μm on the current collector to produce a laminate. Then, the laminate was cut to obtain a strip-shaped positive electrode having a width of 36 mm.

Next, the negative electrode, a microporous polyethylene film separator and the positive electrode were wound spirally, and a terminal was welded thereto. They were placed in a positive electrode can made of aluminum and having a thickness of 4 mm, a width of 34 mm and a height of 43 mm (463443 type), and a lid was attached to the can by welding. Then, 2.5 g of an electrolytic solution (nonaqueous electrolyte) prepared by dissolving 1 mol of LiPF₆ in a solvent at a ratio of EC:DEC=3:7 (volume ratio) was poured into the container through an inlet provided on the lid, followed by sealing of the container, and thus a rectangular nonaqueous secondary battery was obtained.

### Example 2

SiO (average particle size: 1 μm), fiberous carbon (average length: 2 μm, average diameter: 0.08 μm) and 10 g of polyvinyl pyrrolidone were mixed in 1L of ethanol, and they were further mixed using a wet jet mill to obtain a slurry. A total mass of the SiO and the fiberous carbon (CF) used in preparing the slurry was set to 100 g and the mass ratio of SiO to CF was set to 89:11. Next, composite particles of the SiO and the CF were prepared using the slurry by a spray dry method (atmospheric temperature: 200° C.). The composite particles had an average particle size of 10 μm. Subsequently, the composite particles were heated to about 1000° C. in an ebullated bed reactor and brought into contact with mixed gas of benzene and nitrogen gas having a temperature of 25° C., and they were subjected to a CVD treatment at 1000° C. for 60 minutes. In this way, the carbon produced by thermal decomposition of the mixed gas was deposited onto the composite particles to form a coating layer, and thus a negative electrode material (negative electrode active material) was obtained.

The composition of the negative electrode material was determined by calculating a change in the mass before and after the formation of the coating layer and found that the ratio of SiO:CF:CVD carbon was 80:10:10 (mass ratio).

Next, 90 mass % (the content in the total amount of solids, the same applies also in the following) of the negative electrode material, 2 mass % of ketjen black (average particle size: 0.05 μm) as a conductive assistant, 8 mass % of polyamideimide (“HPC-9000-21” manufactured by Hitachi Chemicals Co., Ltd) as a binder and dehydrated NMP were mixed to prepare a negative electrode mixture containing slurry. A negative electrode was produced in the same manner as Example 1 except that this negative electrode mixture containing slurry was used to form negative electrode active material containing layers. A rectangular nonaqueous secondary battery was produced in the same manner as Example 1 except that this negative electrode was used.

### Example 3

SiO (average particle size: 1 μm), graphite (average particle size: 2 μm) and 10 g of polyvinyl pyrrolidone were mixed in 1L of ethanol, and they were further mixed using a wet jet mill to obtain a slurry. The mass ratio of the SiO to the graphite used in preparing the slurry was set to SiO:graphite=91:9. Next, composite particles of the SiO and the graphite were prepared using the slurry by a spray dry method (atmospheric temperature: 200° C.). The composite particles had an average particle size of 15 μm. Subsequently, the composite particles were heated to about 1000° C. in an ebullated bed reactor and brough into contact with mixed gas of benzene and nitrogen gas having a temperature of 25° C., and they were subjected to a CVD treatment at 1000° C. for 60 minutes. In this way, the carbon produced by the thermal decomposition of the mixed gas was deposited onto the composite particles to form a coating layer, and thus the composite particles coated with a carbon coating layer were obtained.

Then, 100 g of the composite particles coated with the carbon coating layer and 40 g of a phenol resin were dispersed in 1L of ethanol, and the dispersion solution was sprayed and dried (atmospheric temperature: 200° C.) to coat the surface of the composite particles coated with the carbon coating layer with the phenol resin. Thereafter, the coated composite particles were baked at 1000° C. to form a material layer containing hardly graphitizable carbon and coating the carbon coating layer, and thus a negative electrode material (negative electrode active material) was obtained.

The composition of the negative electrode material was determined by calculating a change in the mass before and after the formation of the carbon coating layer and before and after the formation of the material layer containing hardly graphitizable carbon, and found that the ratio of SiO:graphite:CVD carbon:hardly graphitizable carbon was 75:7:10:8 (mass ratio).

Subsequently, 90 mass % (the content in the total amount of solids, the same applies also in the following) of the negative electrode material, 2 mass % of ketjen black (average particle size: 0.05 μm) as a conductive assistant, 8 mass % of polyamideimide (“HPC-9000-21” manufactured by Hitachi Chemicals Co., Ltd) as a binder and dehydrated NMP were mixed to prepare a negative electrode mixture containing slurry. A negative electrode was produced in the same manner as Example 1 except that this negative electrode mixture containing slurry was used to form negative electrode active material containing layers. A rectangular nonaqueous secondary battery was produced in the same manner as Example 1 except that this negative electrode was used.

### Example 4

SiO (average particle size: 1 μm), graphite (average particle size: 3 μm) and polyethylene resin particles as a binder were put in a 4L container made of stainless steel. Balls made of stainless steel were further placed in the container, and the SiO, the graphite and the polyethylene resin particles were mixed, pulverized, and granulated for 3 hours using a vibrating mill. As a result, composite particles (composite particles of SiO and graphite) having an average particle size of 20 μm were produced. Subsequently, the composite particles were heated to about 950° C. in an ebullated bed reactor and brought into contact with mixed gas of toluene and nitrogen gas having a temperature of 25° C., and they were subjected to a CVD treatment at 950° C. for 60 minutes. In this way, the carbon produced by the thermal decomposition of the mixed gas was deposited onto the composite particles to form a coating layer, and thus a negative electrode material (negative electrode active material) was obtained.

The composition of the negative electrode material was determined by calculating a change in the mass before and after the formation of the carbon coating layer and found that the ratio of SiO:graphite:CVD carbon was 80:10:10 (mass ratio).

Subsequently, 90 mass % (the content in the total amount of solids, the same applies also in the following) of the negative electrode material, 2 mass % of ketjen black (average particle size: 0.05 μm) as a conductive assistant, 8 mass % of polyamideimide (“HPC-9000-21” manufactured by Hitachi Chemicals Co., Ltd) as a binder and dehydrated NMP were mixed to prepare a negative electrode mixture containing slurry. A negative electrode was produced in the same manner as Example 1 except that this negative electrode mixture containing slurry was used to form negative electrode active material containing layers. A rectangular nonaqueous secondary battery was produced in the same manner as Example 1 except that this negative electrode was used.

### Example 5

A negative electrode was produced in the same manner as Example 1 except that the binder in the negative electrode mixture was changed to polyimide. Except using this negative electrode, a rectangular nonaqueous secondary battery was produced in the same manner as Example 1.

### Example 6

95 mass % (the content in the total amount of solids, the same applies also in the following) of α-alumina, 5 mass % of polyamideimide (“HPC-9000-21” manufactured by Hitachi Chemicals Co., Ltd) and dehydrated NMP, all of which were the same components as those used in Example 1, were mixed to prepare a slurry for forming a coating layer. A negative electrode was produced in the same manner as Example 1 except that this slurry for forming a coating layer was used to form coating layers on the surface of negative electrode active material containing layers. Except using this negative electrode, a rectangular nonaqueous secondary battery was produced in the same manner as Example 1.

### Example 7

A negative electrode was produced in the same manner as Example 1 except that no coating layer was formed. Except using this negative electrode, a rectangular nonaqueous secondary battery was produced in the same manner as Example 1.

### Example 8

A negative electrode was produced in the same manner as Example 1 except that the binder in the negative electrode mixture was changed to PVDF. Except using this negative electrode, a rectangular nonaqueous secondary battery was produced in the same manner as Example 1.

### Comparative Example 1

A negative electrode was produced in the same manner as Example 1 except that the current collector in the negative electrode was changed to an electrolytic copper foil (thickness: 10 μm, 0.2% proof stress: 210 N/mm², tensile strength: 250 N/mm²). Except using this negative electrode, a rectangular nonaqueous secondary battery was produced in the same manner as Example 1.

### Comparative Example 2

A negative electrode was produced in the same manner as Comparative Example 1 except that the binder in the negative electrode mixture was changed to PVDF. Except using this negative electrode, a rectangular nonaqueous secondary battery was produced in the same manner as Example 1.

### Comparative Example 3

A negative electrode was produced in the same manner as Comparative Example 1 except that no coating layer was formed. Except using this negative electrode, a rectangular nonaqueous secondary battery was produced in the same manner as Example 1.

### Comparative Example 4

A negative electrode was produced in the same manner as Comparative Example 1 except that the binder in the negative electrode mixture was changed to PVDF and no coating layer was formed. Except using this negative electrode, a rectangular nonaqueous secondary battery was produced in the same manner as Example 1.

### Comparative Example 5

A negative electrode was produced in the same manner as Example 1 except that the current collector in the negative electrode was changed to a highly stretched copper foil (0.2% proof stress: 80 N/mm², tensile strength: 120 N/mm²) having a thickness of 10 μm. Except using this negative electrode, a rectangular nonaqueous secondary battery was produced in the same manner as Example 1.

With respect to the batteries of Examples 1 to 8 and Comparative Examples 1 to 5, a change in the thickness at the time of charging and the discharge capacity were measured, and the charge/discharge cycle characteristic (capacity retention rate at a 200th charge/discharge cycle) of each battery was evaluated.

At the discharge capacity measurement and the charge/discharge cycle evaluation, each battery was charged/discharged as follows. First, each battery was charged at a constant current of 400 mA until the charge voltage reached 4.2 V, and then was charged at a constant voltage until the current became 1/10. Each battery was discharged at a constant current of 400 mA with an end-of-discharge voltage being set to 2.5 V. A series of the charging and discharging operations was given as one cycle. The discharge capacity (C1) of each battery at the second charge/discharge cycle was used to evaluate the discharge capacity. Further, from C1 and the discharge capacity (C2) at the 200th cycle, a capacity retention rate at the 200th cycle was calculated by the following equation:

Capacity retention rate (%)=(C2/C1)×100.

Further, a change in the thickness of each battery at the time of charging was measured as follows. Under the same charge/discharge conditions as in the battery characteristic evaluation, the thickness of each battery was measured after the charging at the first cycle, and the difference from the thickness before the charging (about 4 mm) was determined.

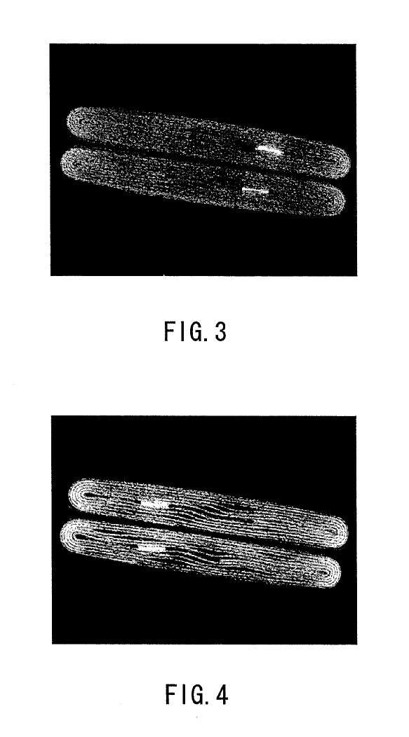

Table 1 provides the results of measuring the discharge capacity and a change in the thickness at the time of charging and the discharge capacity retention rate at the 200th cycle of each battery, together with the 0.2% proof stress and the tensile strength of each negative electrode current collector. Further, FIG. 2 shows the charge/discharge cycle characteristic of the nonaqueous secondary battery of Example 1 and that of the nonaqueous secondary battery of Comparative Example 1. Moreover, FIGS. 3 and 4 respectively show cross-sectional X-ray CT (Computed Tomography) images of the nonaqueous secondary batteries of Example 1 and Comparative Example 1 after the charge/discharge cycle characteristic evaluation.

In the graph of FIG. 2, the horizontal axis indicates charge/discharge cycles and the vertical axis indicates discharge capacity retention rate at each cycle relative to the discharge capacity at the second charge/discharge cycle. Further, FIG. 3 shows an image of the nonaqueous secondary battery of Example 1 and FIG. 4 shows an image of the nonaqueous secondary battery of Comparative Example 1.

TABLE 1

| | | | | Discharge | Change in |
|---|---|---|---|---|---|
| | Negative electrode | | | capacity | thickness |
| | current collector | | | retention | of |
| | 0.2% | | | rate | battery at |
| | proof | Tensile | Discharge | (200th | time of |
| | stress | strength | capacity | cycle) | charging |
| | (N/mm²) | (N/mm²) | (mAh) | (%) | (mm) |
| Ex. 1 | 270 | 350 | 900 | 76 | 0.40 |
| Ex. 2 | 270 | 350 | 900 | 76 | 0.40 |
| Ex. 3 | 270 | 350 | 870 | 76 | 0.40 |
| Ex. 4 | 270 | 350 | 900 | 76 | 0.40 |
| Ex. 5 | 270 | 350 | 900 | 78 | 0.35 |
| Ex. 6 | 270 | 350 | 900 | 78 | 0.35 |
| Ex. 7 | 270 | 350 | 900 | 74 | 0.45 |
| Ex. 8 | 270 | 350 | 900 | 64 | 0.45 |
| Comp. Ex. 1 | 210 | 250 | 900 | 73 | 0.95 |
| Comp. Ex. 2 | 210 | 250 | 900 | 60 | 1.00 |
| Comp. Ex. 3 | 210 | 250 | 900 | 70 | 1.00 |
| Comp. Ex. 4 | 210 | 250 | 900 | 58 | 1.05 |
| Comp. Ex. 5 | 80 | 120 | 900 | 72 | 1.70 |

As can be seen from Table 1 and FIG. 2, the rectangular nonaqueous secondary batteries of Examples 1 to 8 have a high capacity and a change in the thickness was smaller than the rectangular nonaqueous secondary batteries of Comparative Examples 1 to 5. Further, the batteries of Examples 1 to 8 (especially, the batteries of Examples 1 to 7) have a high discharge capacity retention rate after being charged/discharged repeatedly, meaning that they have a favorable charge/discharge cycle characteristic. As is evident from FIGS. 3 and 4, in the case of the battery of Comparative Example 1 in which the negative electrode current collector is changed to an electrolytic copper foil (thickness: 10 μm), a deformation of the wound electrode body in the vertical direction can be observed in the figure. In contrast, in the battery of Example 1 in which a high-strength copper foil (thickness: 10 μm) was used as the negative electrode current collector, such electrode body deformation was suppressed.

It is believed that each of the aforementioned results is due to the following. In each of the batteries of Examples 1 to 8, deformations such as a change in the volume and curving of the negative electrode resulting from the expansion of the active material at the time of charging was suppressed sufficiently as a result of using a high-strength copper foil having a large 0.2% proof stress or tensile strength as the negative electrode current collector; forming the coating layers on the surface of the negative electrode active material containing layers; and using a specific binder in the negative electrode active material containing layers.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

According to the present invention, it is possible to provide a high-capacity nonaqueous secondary battery with a favorable charge/discharge cycle characteristic and suppressed battery swelling.

### DESCRIPTION OF REFERENCE NUMERALS

1 negative electrode

2 coating layer (porous layer containing insulating material not reactive with Li)

3 negative electrode active material containing layer

4 current collector

1. A nonaqueous secondary battery comprising a positive electrode, a negative electrode and a nonaqueous electrolyte,
wherein the positive electrode includes a positive electrode current collector,
a positive electrode active material containing layer containing an Li-containing transition metal oxide is disposed on at least one side of the positive electrode current collector,
the negative electrode includes a negative electrode current collector,
a negative electrode active material containing layer containing a negative electrode active material including an element that can be alloyed with Li is disposed on at least one side of the negative electrode current collector,
a porous layer containing an insulating material not reactive with Li is disposed on a surface of the negative electrode active material containing layer opposite to a side facing the negative electrode current collector, and
the negative electrode current collector has a 0.2% proof stress of 250 N/mm² or more or the negative electrode current collector has a tensile strength of 300 N/mm² or more.

2. The nonaqueous secondary battery according to claim 1, wherein the negative electrode active material containing layer contains at least one binder selected from the group consisting of polyimide, polyamideimide and polyamide.

3. The nonaqueous secondary battery according to claim 1, wherein the insulating material not reactive with Li is alumia or boehmite.

4. The nonaqueous secondary battery according to claim 1, wherein the porous layer contains at least one binder selected from the group consisting of polyimide, polyamideimide and polyamide.

5. The nonaqueous secondary battery according to claim 1, wherein the porous layer has a thickness of 2 to 10 μm.

6. The nonaqueous secondary battery according to claim 1, wherein the negative electrode current collector is composed of a Cu alloy including at least one element selected from the group consisting of Zr, Cr, Sn, Zn, Ni, Si and P.

7. The nonaqueous secondary battery according to claim 1, wherein the element that can be alloyed with Li is Si and/or Sn.

8. The nonaqueous secondary battery according to claim 1, wherein the negative electrode active material includes Si and O as constituent elements, and an atomic ratio x of O to Si is 0.5≦x≦1.5.

9. The nonaqueous secondary battery according to claim 1, wherein the negative electrode active material containing layer contains a carbon material as a conductive material.

10. The nonaqueous secondary battery according to claim 1, wherein the negative electrode active material is a composite of a carbon material and a material including Si and O as constituent elements and an atomic ratio x of O to Si being 0.5≦x≦1.5.

11. The nonaqueous secondary battery according to claim 10, wherein a surface of the composite is further coated with a carbon material.

12. The nonaqueous secondary battery according to claim 9, wherein an amount of the conductive material in the negative electrode active material containing layer is 5 to 50 mass %.

13. A nonaqueous secondary battery comprising a positive electrode, a negative electrode and a nonaqueous electrolyte,
wherein the positive electrode includes a positive electrode current collector,
a positive electrode active material containing layer containing a Li-containing transition metal oxide is disposed on at least one side of the positive electrode current collector,
the negative electrode includes a negative electrode current collector,
a negative electrode active material containing layer containing a negative electrode active material including an element that can be alloyed with Li and at least one binder selected from the group consisting of polyimide, polyamideimide and polyamide is disposed on at least one side of the negative electrode current collector, and
the negative electrode current collector has a 0.2% proof stress of 250 N/mm² or more or the negative electrode current collector has a tensile strength of 300 N/mm² or more.

14. The nonaqueous secondary battery according to claim 13, wherein the negative electrode current collector is composed of a Cu alloy including at least one element selected from the group consisting of Zr, Cr, Sn, Zn, Ni, Si and P.

15. The nonaqueous secondary battery according to claim 13, wherein the element that can be alloyed with Li is Si, Sn or a mixture thereof.

16. The nonaqueous secondary battery according to claim 13, wherein the negative electrode active material includes Si and O as constituent elements, and an atomic ratio x of O to Si is 0.5≦x≦1.5.

17. The nonaqueous secondary battery according to claim 13, wherein the negative electrode active material containing layer contains a carbon material as a conductive material.

18. The nonaqueous secondary battery according to claim 13, wherein the negative electrode active material is a composite of a carbon material and a material including Si and O as constituent elements and an atomic ratio x of O to Si being 0.5≦x≦1.5.

19. The nonaqueous secondary battery according to claim 18, wherein a surface of the composite is further coated with a carbon material.

20. The nonaqueous secondary battery according to claim 17, wherein an amount of the conductive material in the negative electrode active material containing layer is 5 to 50 mass %.
